(19) United States
(12) Patent Application Publication
(10) Pub. No.: US 2025/0386186 A1
(43) Pub. Date: Dec. 18, 2025

(54) AUTHENTICATION ENHANCEMENTS FOR WIRELESS NETWORKS

(71) Applicant: Samsung Electronics Co., Ltd., Suwon-si (KR)

(72) Inventors: Peshal Nayak, Plano, TX (US); Boon Loong Ng, Plano, TX (US); Rubayet Shafin, Allen, TX (US); Vishnu Vardhan Ratnam, Frisco, TX (US); Yue Qi, Plano, TX (US); Bilal Sadiq, Plano, TX (US)

(21) Appl. No.: 19/224,504

(22) Filed: May 30, 2025

Related U.S. Application Data
(60) Provisional application No. 63/659,273, filed on Jun. 12, 2024.
(60) Provisional application No. 63/781,627, filed on Apr. 1, 2025.

(51) Int. Cl. H04W 12/04; H04W 36/00; H04W 84/12

(52) U.S. Cl. CPC H04W 12/04; H04W 36/0038; H04W 84/12

(57) ABSTRACT

In an embodiment, a station (STA) may transmit an authentication request to a current AP to be authenticated with one or more target access points (APs) and the current AP may communicate with the one or more target APs to authenticate the STA and to perform a context transfer of one or more contexts or agreements to the target APs. The current AP and the target APs may be part of a seamless roaming domain, which may provide functionalities for performing the authentication and context transfer.

### CROSS-REFERENCE TO RELATED APPLICATIONS

This application claims the benefit of priority from U.S. Provisional Application No. 63/659,273 entitled “AUTHENTICATION ENHANCEMENTS FOR NEXT GENERATION WLANS” filed Jun. 12, 2024; and U.S. Provisional Application No. 63/781,627, entitled “AUTHENTICATION ENHANCEMENTS FOR NEXT GENERATION WLANS” filed Apr. 1, 2025, all of which are incorporated herein by reference in their entireties.

### TECHNICAL FIELD

This disclosure relates generally to a wireless communication system, and more particularly to, for example, but not limited to, authentication enhancements for wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHz, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access-point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

The description set forth in the background section should not be assumed to be prior art merely because it is set forth in the background section. The background section may describe aspects or embodiments of the present disclosure.

### SUMMARY

One aspect of the present disclosure provides a station (STA) in a wireless network, the STA comprising: a memory; and a processor coupled to the memory. The processor is configured to transmit, to a first access point (AP) associated with the STA and that is a part of a seamless mobility domain (SMD) comprising a plurality of APs, a first frame including (i) a request to authenticate the STA with the SMD and (ii) a SMD identifier identifying the SMD. The processor is configured to receive, from the first AP, a second frame providing a response to the request to authenticate the STA. The processor is configured to determine, based on the second frame, whether authentication with the SMD is successful. The processor is configured to initiate roaming from the first AP to a second AP based on a determination that the authentication with the SMD is successful, wherein the second AP is a part of the SMD.

In some embodiments, the processor is further configured to maintain the association with the first AP based on a determination that the authentication with the SMD has failed.

In some embodiments, the first frame includes an element that includes (i) information identifying the SMD, (ii) information describing one or more capabilities of the SMD, or (iii) information describing one or more constraints of the SMD.

In some embodiments, the second frame includes an element that includes (i) information identifying the SMD, (ii) information describing one or more capabilities of the SMD, or (iii) information describing one or more constraints of the SMD

In some embodiments, the processor is further configured to establish a single pairwise master key security association (PMKSA) with a management entity of the SMD using the SMD identifier, wherein the PMKSA includes an SMD level pairwise master key (PMK).

In some embodiments, the processor is further configured to: communicate with a management entity of the SMD to associate with the SMD.

In some embodiments, the processor is further configured to derive an SMD level pairwise transient key (PTK) between the STA and the management entity of the SMD using the SMD identifier.

One aspect of the present disclosure provides an access point (AP) in a wireless network, the AP comprising: a memory; and a processor coupled to the memory. The processor is configured to receive, from a station (STA) associated with the AP, a first frame including (i) a request to authenticate the STA with a seamless mobility domain (SMD) comprising a plurality of APs that the AP is a part of and (ii) a SMD identifier identifying the SMD. The processor is configured to authenticate, with a management entity of the SMD, the STA. The processor is configured to transmit, to the STA, a second frame that indicates whether the authentication with the SMD is successful.

In some embodiments, the first frame includes an element that includes (i) information identifying the SMD, (ii) information describing one or more capabilities of the SMD, or (iii) information describing one or more constraints of the SMD.

In some embodiments, the second frame includes an element that includes (i) information identifying the SMD, (ii) information describing one or more capabilities of the SMD, or (iii) information describing one or more constraints of the SMD

In some embodiments, the processor is further configured to establish a single pairwise master key security association (PMKSA) with the management entity of the SMD using the SMD identifier, wherein the PMKSA includes an SMD level pairwise master key (PMK).

In some embodiments, the processor is further configured to communicate with the management entity of the SMD to associate the STA with the SMD.

In some embodiments, the processor is further configured to: derive an SMD level pairwise transient key (PTK) between the STA and the management entity of the SMD using the SMD identifier.

One aspect of the present disclosure provides a computer-implemented method for wireless communication by a station (STA) in a wireless network. The method comprises transmitting, to a first access point (AP) associated with the STA and that is a part of a seamless mobility domain (SMD), a first frame including (i) a request to authenticate the STA with the SMD and (ii) a SMD identifier identifying the SMD. The method comprises receiving, from the first AP, a second frame providing a response to the request to authenticate the STA. The method comprises determining, based on the second frame, whether authentication with the SMD is successful. The method comprises initiating roaming from the first AP to a second AP based on a determination that the authentication with the SMD is successful, wherein the second AP is a part of the SMD.

In some embodiments, the method further comprises maintaining the association with the first AP based on a determination that the authentication with the SMD has failed.

In some embodiments, the first frame includes an element that includes (i) information identifying the SMD, (ii) information describing one or more capabilities of the SMD, or (iii) information describing one or more constraints of the SMD.

In some embodiments, the second frame includes an element that includes (i) information identifying the SMD, (ii) information describing one or more capabilities of the SMD, or (iii) information describing one or more constraints of the SMD.

In some embodiments, the method further comprises establishing a single pairwise master key security association (PMKSA) with a management entity of the SMD using the SMD identifier, wherein the PMKSA includes an SMD level pairwise master key (PMK).

In some embodiments, the method further comprises communicating with a management entity of the SMD to associate with the SMD.

In some embodiments, the method further comprises deriving an SMD level pairwise transient key (PTK) between the STA and the management entity of the SMD using the SMD identifier.

### BRIEF DESCRIPTION OF THE DRAWINGS

FIG. 1 illustrates an example of a wireless network in accordance with an embodiment.

FIG. 2A illustrates an example of AP in accordance with an embodiment.

FIG. 2B illustrates an example of STA in accordance with an embodiment.

FIG. 3 illustrates an example of multi-link communication operation in accordance with an embodiment.

FIG. 4 illustrates stages of a mobility handover procedure in accordance with an embodiment.

FIG. 5 illustrates an authentication with a context transfer check in accordance with an embodiment.

FIG. 6 illustrates an authentication with context transfer feasibility check in accordance with an embodiment.

FIG. 7 illustrates a flow chart of an example process for an authentication request in accordance with an embodiment.

FIG. 8 illustrates a flow chart of an example process for an authentication response in accordance with an embodiment.

FIG. 9 illustrates an example format of a seamless mobility domain (SMD) element in accordance with an embodiment.

FIG. 10 illustrates an example authentication in accordance with an embodiment.

FIG. 11 illustrates a flow chart of an example process for authentication failure in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter.

As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

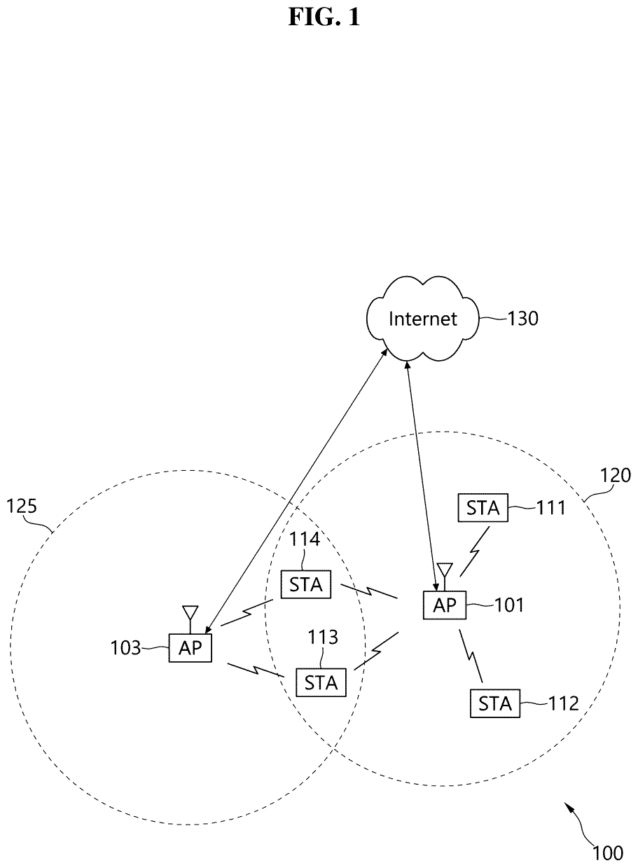

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs. Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

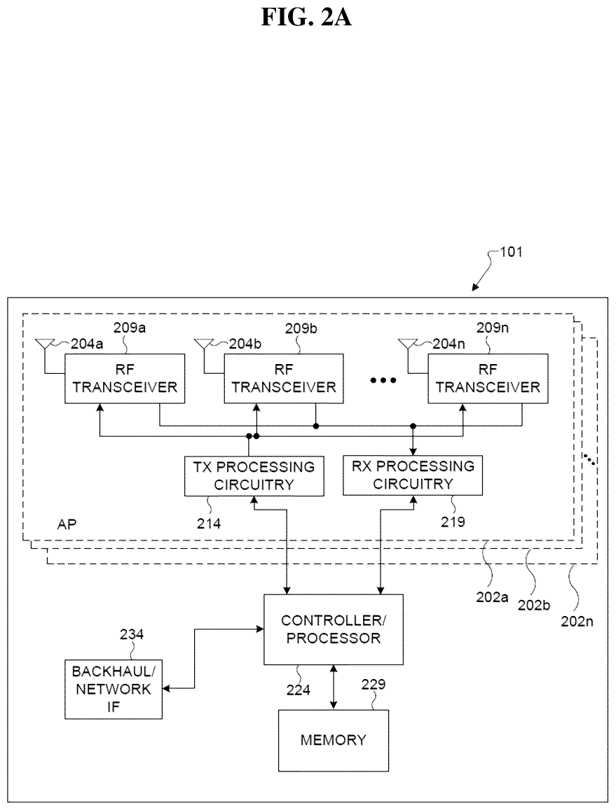

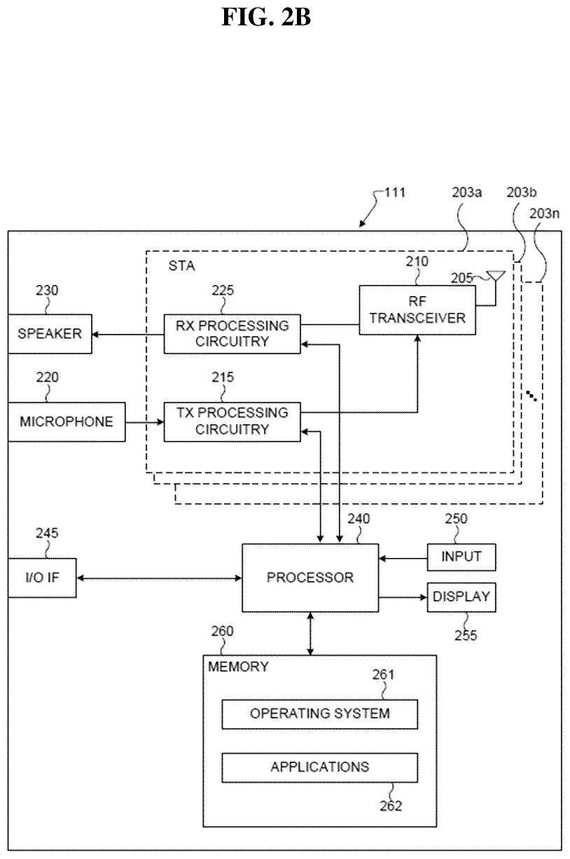

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementation of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiments, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiments, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

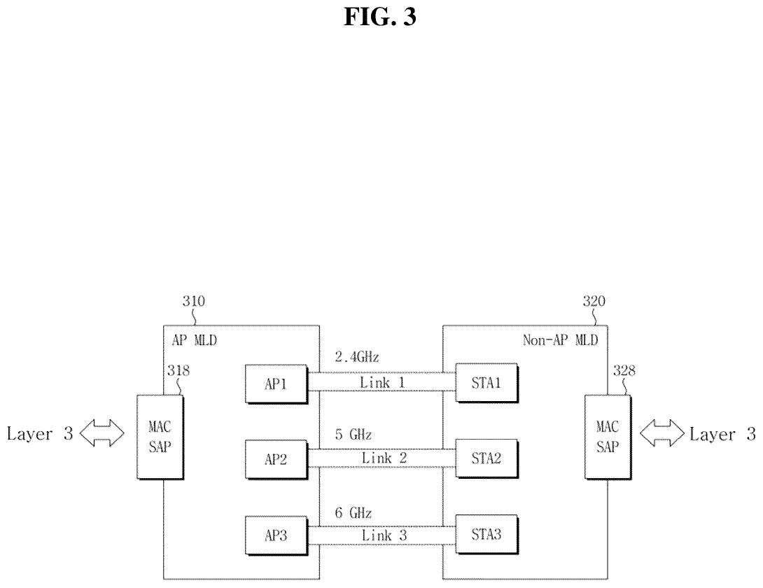

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHz band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and iii) IEEE P802.11be/D5.0, “Wireless LAN Medium Access Control (MAC) and Physical Layer (PHY) Specifications.

As users move around an environment while holding a STA device, a signal strength of the STA to its connected AP can vary. If a user's movement causes a significant decrease in a signal strength, a handover may be necessary. During the handover process, an STA may switch from an associated AP, which may be referred to herein as current AP (CAP), to a new AP.

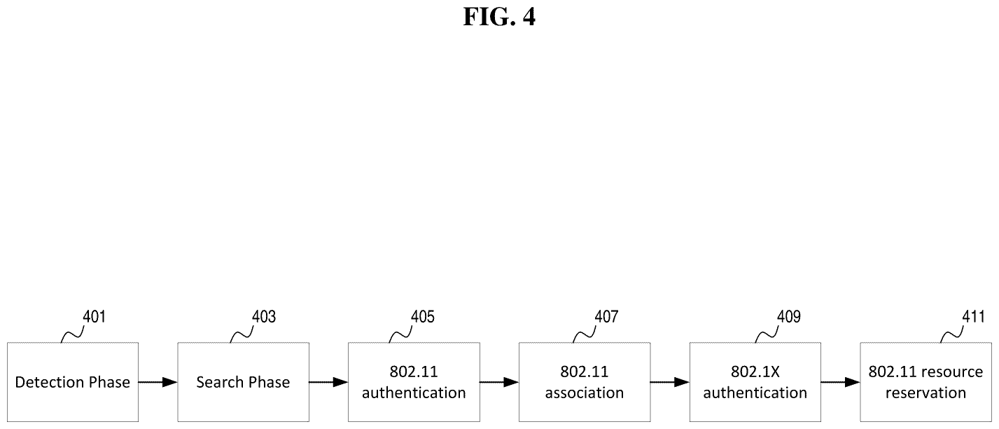

FIG. 4 illustrates stages of a mobility handover procedure in accordance with an embodiment. As shown in FIG. 4, in legacy devices without any mobility support, the handover procedure may involve several steps, including a detection phase 401, a search phase 403, an 802.11 authentication phase 405, an 802.11 association phase 407, an 802.1X authentication phase 409, and an 802.11 resource reservation phase 411.

During the detection phase 401, an STA may determine that there is a need for a handover. The procedures to detect a need for handover may be vendor specific. For instance, a particular vendor implementation may choose to trigger a handover when the signal strength to the currently associated AP drops below a certain threshold.

The detection phase 401 may be followed by a search phase 403. During the search phase 403, the STA may search for new APs to associate with. During the search phase 403, the STA may perform a scan of different channels to identify APs in the vicinity. This can be done either passively (e.g., listening to beacons on a particular channel) or actively (e.g., by the use of probe request and response procedure).

After the scanning procedure is complete, the next step is to perform 802.11 authentication (open system/shared key based) 405. Once the STA is authenticated, the next step is to perform 802.11 association 807. Introduced in IEEE 802.11i amendment, the 802.1X authentication phase 409 may include an EAP authentication between the STA and a AAA server with the assistance of the AP. Finally, during the 802.11 resource reservation phase 411, the STA may set up various resources at the new AP. For example, the STA can perform quality of service (QoS) reservation, BA setup, etc. with the newly associated AP.

Typically, during a handover, there can be a disruption in the connection as the setup procedure operates in a break-before-make manner. This can cause an impact on user experience especially with multimedia services which can suffer from session disruptions due to the high delay encountered during handover procedure.

In order to reduce the handover delay, a number of procedures have been introduced in several standards. The focus of these procedures is to remove or reduce the delay encountered in various steps of the handover procedure. In 2008, IEEE 802.11r introduced a fast transition roaming which may eliminate the need for the authentication step (e.g., 802.11 authentication 405 in FIG. 4) during the handover. In 2011, IEEE 802.11k introduced assisted roaming which may reduce the search phase (e.g., search phase 403 in FIG. 4) by allowing the STA to request the AP to send channel information of candidate neighbor APs. In 2011, IEEE 802.11v also introduced network assisted roaming to assist the search phase. Thus, with a combination of IEEE 802.11v and IEEE 802.11k support, the search time can be reduced by enabling the device to scan only those channels on which APs in the vicinity operate. In IEEE 802.11be, the fast BSS transition procedure was extended to cover the case of multi-link operation (MLO). This procedure helps to reduce the delays encountered due to IEE 802.11 resource reservation (e.g., 802.11 resource reservation 411 in FIG. 4).

In next generation wireless network, a number of APs can coordinate with each other to form a seamless mobility domain. With a seamless mobility domain, roaming from one AP to another AP can be done seamlessly by a STA (e.g., without requiring (Re) association). In some embodiments, the STA may indicate to the STA's current AP the candidate APs that the STA may intend to roam to. The current AP may then coordinate with the candidate APs to ensure a seamless roam for the STA (e.g., preparing potential target AP(s) for the roam). In particular, when the STA detects a need to roam, the STA can inform the current AP about which target AP the STA intends to roam to and the current AP may communicate with the one or more target APs to determine whether the target APs are available for roaming and provide a response message to the STA, upon which the STA may roam to a target AP that is available for roaming.

In some embodiments, authentication with the target AP can be performed via the current AP. An authentication request message may also request a current AP to perform a context transfer feasibility check or a context transfer request for near static contexts or agreements. As described herein, the term context transfer may refer to a transfer of one or more context or one or more agreements. The context or agreements may be near static contexts of agreements (e.g., target wake time (TWT) agreements, among others). A context transfer may generally refer to transferring a current state of information with a current AP to a target AP, including network settings, authentication details, or active connections, among others.

Upon receiving the authentication request message, the current AP may perform a context transfer of near static contexts or agreement. In certain embodiments, the current AP may also check if such a context transfer is possible or not.

In some embodiments, the target AP may provide a deadline to the current AP until which the target AP may commit to taking the context or agreements for the indicated STA.

In some embodiments, the current AP may convey the deadline information to the STA. If the STA does not roam to the target AP prior to this deadline, then the STA may need to perform another authentication or context transfer.

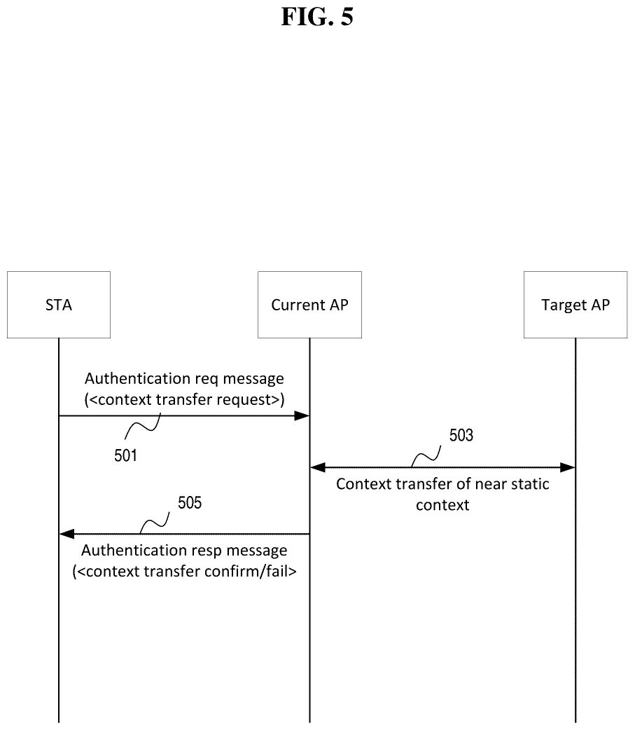

FIG. 5 illustrates a ladder diagram for authentication with a context transfer check in accordance with an embodiment. In particular, FIG. 5 illustrates communication among an STA, a current AP, and a target AP. In operation 501, the STA transmits to the current AP, an authentication request message that includes a context transfer request. In some embodiments, the authentication request frame may include an information message about the seamless mobility domain (SMD). In some embodiments, a SMD may include a logical grouping of one or more APs that share information to allow a STA to perform smooth transitioning between the APs during roaming. In some embodiments, a seamless mobility domain includes one or more controllers that share information about their associated STAs and APs allowing for a smooth transition during roaming.

The information message may include one or more of the information items set forth in Table 1 below. In some embodiments, the authentication request message may request the current AP to perform a context transfer request for near static contexts or agreements. Accordingly, upon receiving the authentication request message, the current AP may perform a context transfer of near static contexts or agreements. In particular, in operation 503, the current AP may communicate with the target AP to perform the context transfer of near static context or agreements. In some embodiments, the target AP may also provide a time deadline to the current AP until which the target AP may commit to taking the context or agreements for the STA. In operation 505, the current AP transmits to the STA, an authentication response message confirm/fail that indicates whether the context transfer is confirmed or if the context transfer has failed. The current AP may also provide the time deadline information to the STA. If the STA does not perform roaming to the target AP prior to this time deadline, then the STA may need to perform another authentication and/or context transfer.

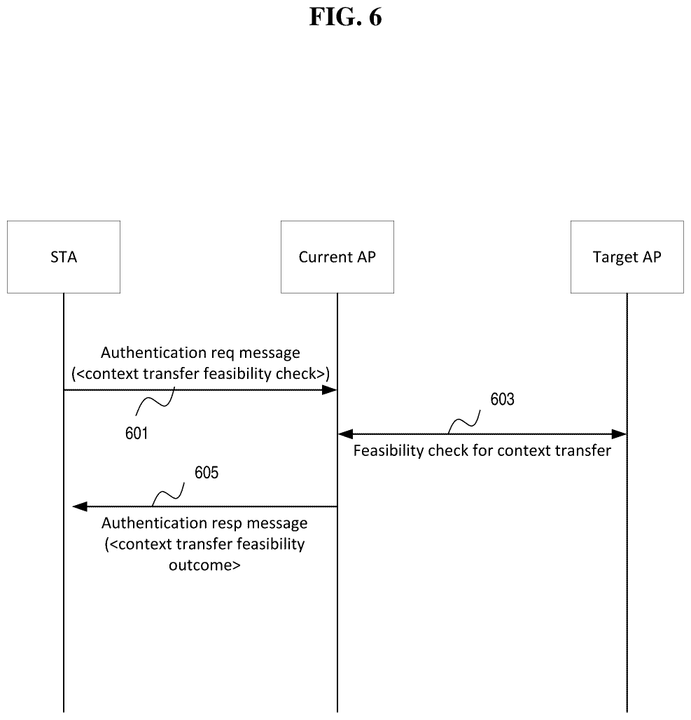

FIG. 6 illustrates an authentication with context transfer feasibility check in accordance with an embodiment. In particular, FIG. 6 illustrates communication among an STA, a current AP, and a target AP. In operation 601, the STA transmits to the current AP, an authentication request message that may include a context transfer feasibility check. In some embodiments, the authentication request message may request the current AP to perform a context transfer feasibility check. Accordingly, in operation 603, the current AP may communicate with the target AP regarding the feasibility check for the context transfer. In operation 605, the current AP transmits to the STA, an authentication response message that indicates the feasibility of the context transfer. In some embodiments, the feasibility may provide an indication regarding whether or not a target AP will be able to accommodate a context transfer. In some embodiments, an authentication, context transfer or feasibility check may be performed simultaneously with multiple target APs at the same time.

In some embodiments, a seamless mobility domain management entity (SMD-ME) may provide SMD level authentication and association functionalities. In some embodiments, the SMD-ME may be one or more controllers that manage the SMD and share information with one or more APs affiliated with the SMD to allow for seamless roaming. In some embodiments, the SMD-ME may be responsible for managing mobility, authentication, and session handling of STAs and may ensure a seamless connection even as an STA roams across the APs in the SMD.

In some embodiments, an authentication frame may include an information message about the SMD. The information message may include one or more of the information items as shown in Table 1.

Table 1 provides information items that can be present in an information message in accordance with an embodiment.

TABLE 1

| Information items | Description |
|---|---|
| SMD identifier | One or more information items that can identify the SMD. e.g., media |
| | access control (MAC) address or an identifier that has the format of |
| | an MAC address. |
| SMD capabilities | One or more information items that can describe the capabilities of the |
| | SMD. e.g., MAC and physical layer (PHY) capabilities. |
| SMD constraints | One or more information items that can describe any constraints of the |
| | SMD. e.g., certain features being disabled in the SMD, among other |
| | information. |

In some embodiments, the information message may be included in an authentication request frame. For example, the authentication request frame transmitted by the non-AP MLD to an AP MLD that is a part of the SMD. In some embodiments, when the information message is included in an authentication request frame, the SMD capabilities and SMD constraints may be reserved. In some embodiments, when the information message is included in an authentication request frame, the SMD capabilities and SMD constraints may be used to make a necessary indication on capabilities and constraints.

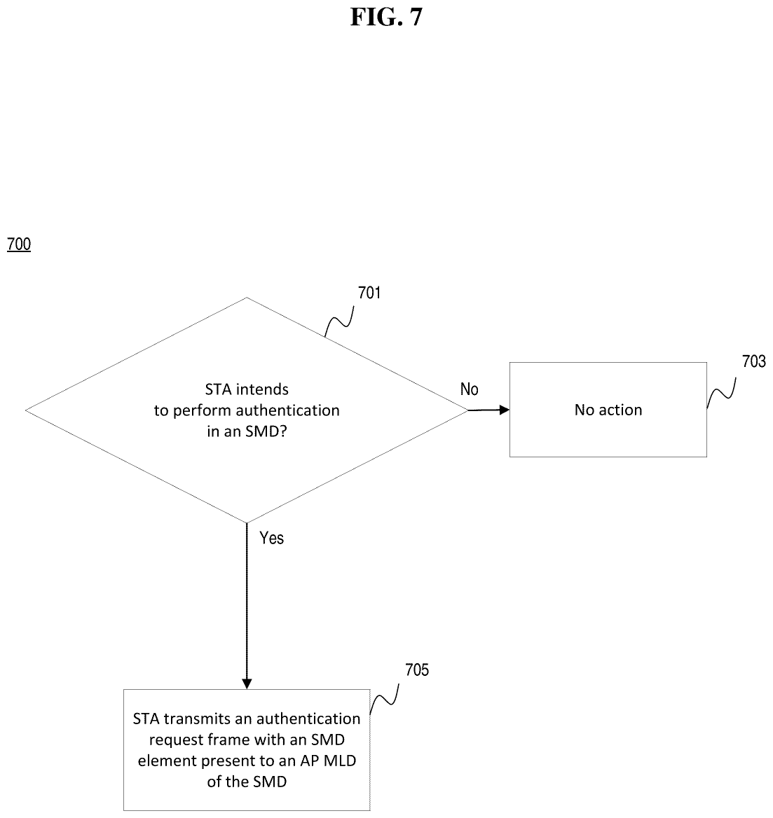

FIG. 7 illustrates a flow chart of an example process for an authentication request in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 7 illustrates operations performed in a non-AP MLD or STA, such as the non-AP MLD or STA illustrated in FIG. 3.

The process 700, in operation 701, the STA determines whether the STA intends to perform authentication in an SMD. If the STA determines that the STA does not intend to perform authentication in the SMD, the process proceeds to operation 703 where the STA performs no action. If the STA determines that the STA does intend to perform authentication in the SMD, the process proceeds to operation 705.

In operation 705, the STA transmits an authentication request frame that includes an SMD element present to an AP MLD of the SMD.

In some embodiments, an information message may be included in an authentication response frame. For instance, an authentication response frame transmitted by the AP MLD that is a part of the SMD to a non-AP MLD.

In some embodiments, when the information message is included in an authentication response frame, the SMD capabilities and SMD constraints may make the necessary indication on capabilities and constraints. In some embodiments, the AP MLD that includes the information message may be required to include the SMD capabilities and constraints information in the message.

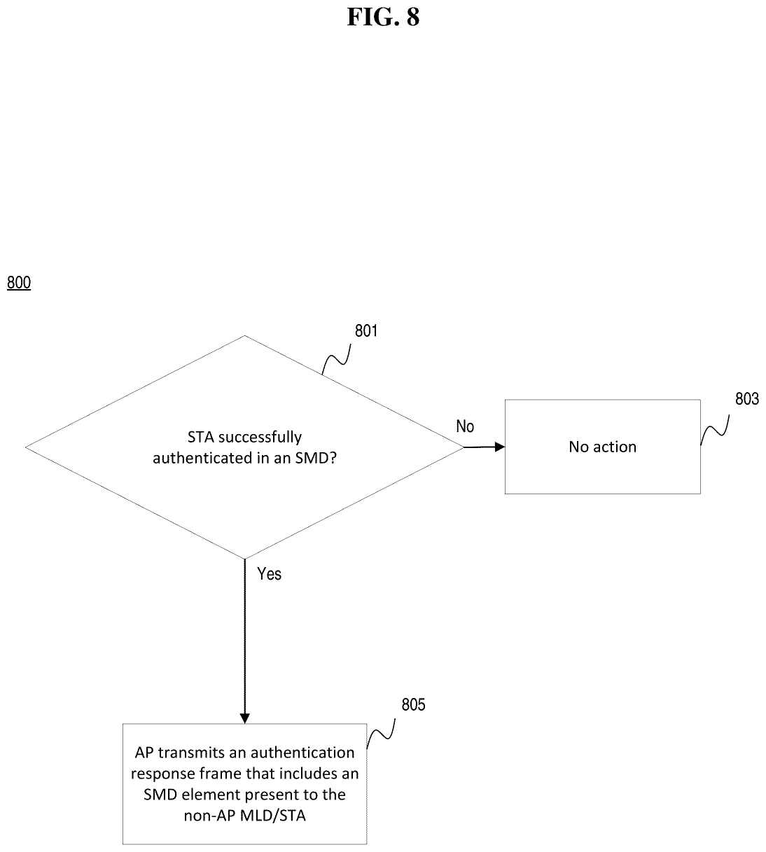

FIG. 8 illustrates a flow chart of an example process for an authentication response in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 8 illustrates operations performed in an AP MLD or AP, such as the AP MLD or AP illustrated in FIG. 3.

The process 800, in operation 800, the AP determines whether the STA was successfully authenticated in an SMD. If the AP determines that the STA was not successfully authenticated in an SMD, the process proceeds to operation 803 where the AP performs no action. If the AP determines that the STA was successfully authenticated in an SMD, the process proceeds to operation 805.

In operation 805, the AP transmits an authentication response frame that includes an SMD element present to the STA.

In the IEEE 802.11 standards, a Pairwise Master Key (PMK) may be derived after a successful authentication between a STA and an AP. The PMK may be stored on the STA and AP along with other information (e.g., AP's MAC address, PMK expiration, PMK identifier, among others). This other information may be referred to as the Pairwise Master Key Security Association (PMKSA). Accordingly, when a STA roams from a first AP to a second AP, the STA may need to derive the PMKSA again as some components of the PMSKA may change after roaming (e.g., AP MAC address).

In some embodiments, a single Pairwise Master Key Security Association (PMKSA) can be established between the non-AP MLD and the SMD-ME by using the SMD identifier. The PMKSA may include an SMD level PMK. Accordingly, instead of the AP MAC address, the PMKSA may have the SMD identifier. When a STA performs roaming from a first AP to a second AP, the SMD identifier may remain the same, and thus a new PMKSA derivation does not need to be performed.

In some embodiments, as a part of an initial association procedure, an SMD level Pairwise Transient Key (PTK) may be derived between the non-AP MLD and the SMD-ME by using the SMD identifier. In particular, the PTK may be derived using the PMK and since the PMKSA may include the SMD level PMK, the PTK may also be an SMD level PTK.

In some embodiments, a PTK may be used to encrypt unicast traffic between a STA and an AP. Accordingly, in an SMD, when a STA performs roaming from one AP to another AP in the same SMD, the STA may continue to use a same PTK and does not need to perform authentication again.

In some embodiments, an information message can be present in an element. In some embodiments, the element may be referred to as an SMD element.

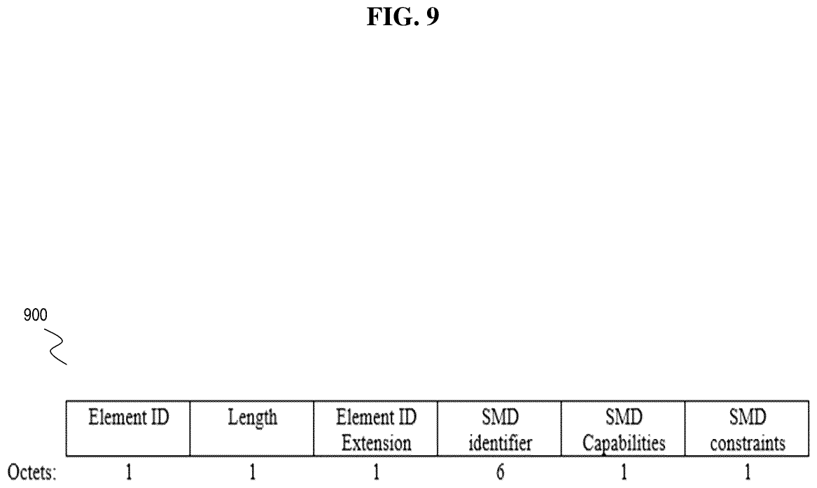

FIG. 9 illustrates an example format of an SMD element 900 in accordance with an embodiment. The SMD element 900 may include an element ID field, a length field, an element ID extension field, a SMD identifier field, a SMD capabilities field, and a SMD constraints field.

The element ID field and the Element ID extension field may provide identifier information for the element 900. The length field may provide length information for the element 900. The SMD identifier field may be a unique identifier for the SMD element 900 and may have a MAC address format. In some embodiments, the SMD identifier field may be six octets in size.

The SMD capabilities field may include one or more information items that describe the capabilities of the SMD (e.g., MAC and PHY capabilities, among others). In some embodiments, the SMD capabilities field may be one octet in size (e.g., 8 bits) and each bit may correspond to a particular capability indication. A bit value for a particular capability indication may take a value of 1 if the capability is supported and a value of 0 if the capability is not supported.

The SMD constraints field may include one or more information items that describe constrains of the SMD (e.g., certain features being disabled in the SMD, among other information). In some embodiments, the SMD constraints field may be one octet in size (e.g., 8 bits) and each bit may correspond to a particular SMD constraint. A bit value for a particular constraint can take a value of 1 if the constraint is present and a value of 0 if the constraint is not present.

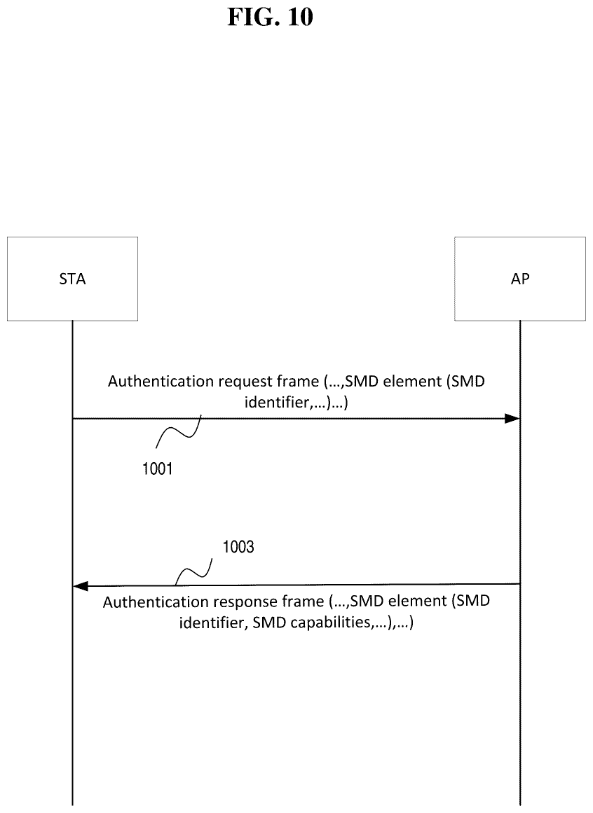

FIG. 10 illustrates an example authentication in accordance with an embodiment. In particular, FIG. 10 illustrates communication between a non-AP MLD (or STA) and an AP MLD (or AP). As illustrated in FIG. 10, in operation 1001, a non-AP MLD may transmit an authentication request frame to an AP MLD that is a part of an SMD. The authentication request frame may include an SMD element which may indicate an SMD identifier.

In operation 1003, in response to this authentication frame, the AP MLD may transmit an authentication response frame to the non-AP MLD. The authentication response frame may include an SMD element with one or more of an SMD identifier and SMD capabilities. The authentication response frame may be transmitted to the non-AP MLD when the authentication is successful.

In some embodiments, if the authentication is not successful, the authentication response frame may include a status code that indicates a failure. In some embodiments, when the authentication is not successful, the SMD element may be absent in the authentication response frame.

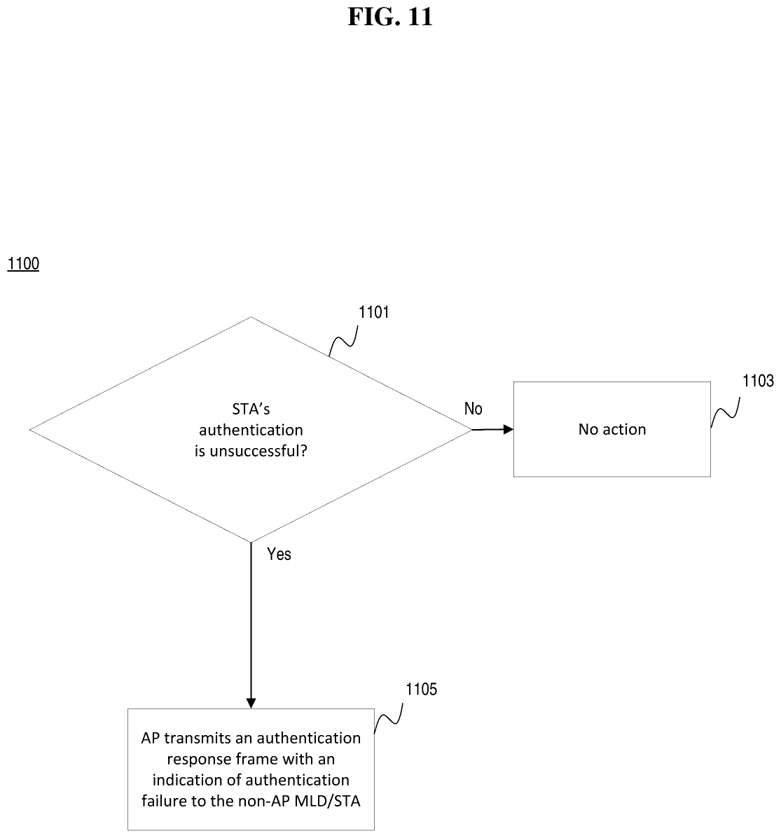

FIG. 11 illustrates a flow chart of an example process for authentication failure in accordance with an embodiment. Although one or more operations are described or shown in a particular sequential order, in other embodiments the operations may be rearranged in a different order, which may include performance of multiple operations in at least partially overlapping time periods. The flowchart depicted in FIG. 11 illustrates operations performed in a AP MLD or AP, such as the AP MLD or AP illustrated in FIG. 3.

The process 1100, in operation 1101, the AP MLD determines whether the non-AP MLD or STA's authentication is unsuccessful. If the AP MLD determines that the non-AP MLDS or STA's authentication is not unsuccessful, the process proceeds to operation 1103 where the AP MLD performs no action. If the AP MLD determines that the non-AP MLDS or STA's authentication is unsuccessful, the process proceeds to operation 1105.

In operation 1105, the AP MLD transmits an authentication response frame that includes an indication of authentication failure to the non-AP MLD or the STA. In some embodiments, if the authentication is not successful, the authentication response frame may include a status code that indicates a failure. In some embodiments, when the authentication is not successful, the SMD element may be absent in the authentication response frame. The processes described herein may also apply to multi-link operation.

Embodiments in accordance with this disclosure provide authentication procedures that include performing a context transfer during the authentication. Accordingly, a STA may communicate with a current AP to transfer one or more static contexts or agreements, which may reduce a delay encountered when the STA performs roaming. Accordingly, embodiments in accordance with this disclosure may perform an enhanced authentication procedure with minimal disruption to ongoing data transmission, providing an improved user experience especially with multimedia services which can suffer from session disruptions due to the high delay encountered during existing handover procedure.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the inventive subject matter. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A station (STA) in a wireless network, the STA comprising:
a memory; and
a processor coupled to the memory, the processor configured to:
transmit, to a first access point (AP) associated with the STA and that is a part of a seamless mobility domain (SMD) comprising a plurality of APs, a first frame including (i) a request to authenticate the STA with the SMD and (ii) a SMD identifier identifying the SMD;
receive, from the first AP, a second frame providing a response to the request to authenticate the STA;
determine, based on the second frame, whether authentication with the SMD is successful; and
initiate roaming from the first AP to a second AP based on a determination that the authentication with the SMD is successful, wherein the second AP is a part of the SMD.

2. The STA of claim 1, wherein the processor is further configured to:
maintain the association with the first AP based on a determination that the authentication with the SMD has failed.

3. The STA of claim 1, wherein the first frame includes an element that includes (i) information identifying the SMD, (ii) information describing one or more capabilities of the SMD, or (iii) information describing one or more constraints of the SMD.

4. The STA of claim 1, wherein the second frame includes an element that includes (i) information identifying the SMD, (ii) information describing one or more capabilities of the SMD, or (iii) information describing one or more constraints of the SMD.

5. The STA of claim 1, wherein the processor is further configured to:
establish a single pairwise master key security association (PMKSA) with a management entity of the SMD using the SMD identifier, wherein the PMKSA includes an SMD level pairwise master key (PMK).

6. The STA of claim 1, wherein the processor is further configured to:
communicate with a management entity of the SMD to associate with the SMD.

7. The STA of claim 6, wherein the processor is further configured to:
derive an SMD level pairwise transient key (PTK) between the STA and the management entity of the SMD using the SMD identifier.

8. An access point (AP) in a wireless network, the AP comprising:
a memory; and
a processor coupled to the memory, the processor configured to:
receive, from a station (STA) associated with the AP, a first frame including (i) a request to authenticate the STA with a seamless mobility domain (SMD) comprising a plurality of APs that the AP is a part of and (ii) a SMD identifier identifying the SMD;
authenticate, with a management entity of the SMD, the STA; and
transmit, to the STA, a second frame that indicates whether the authentication with the SMD is successful.

9. The AP of claim 8, wherein the first frame includes an element that includes (i) information identifying the SMD, (ii) information describing one or more capabilities of the SMD, or (iii) information describing one or more constraints of the SMD.

10. The AP of claim 8, wherein the second frame includes an element that includes (i) information identifying the SMD, (ii) information describing one or more capabilities of the SMD, or (iii) information describing one or more constraints of the SMD.

11. The AP of claim 8, wherein the processor is further configured to:
establish a single pairwise master key security association (PMKSA) with the management entity of the SMD using the SMD identifier, wherein the PMKSA includes an SMD level pairwise master key (PMK).

12. The AP of claim 8, wherein the processor is further configured to:
communicate with the management entity of the SMD to associate the STA with the SMD.

13. The AP of claim 12, wherein the processor is further configured to:
derive an SMD level pairwise transient key (PTK) between the STA and the management entity of the SMD using the SMD identifier.

14. A computer-implemented method for wireless communication by a station (STA) in a wireless network comprising:
transmitting, to a first access point (AP) associated with the STA and that is a part of a seamless mobility domain (SMD), a first frame including (i) a request to authenticate the STA with the SMD and (ii) a SMD identifier identifying the SMD;
receiving, from the first AP, a second frame providing a response to the request to authenticate the STA;
determining, based on the second frame, whether authentication with the SMD is successful; and
initiating roaming from the first AP to a second AP based on a determination that the authentication with the SMD is successful, wherein the second AP is a part of the SMD.

15. The computer-implemented method of claim 14, further comprising:
maintaining the association with the first AP based on a determination that the authentication with the SMD has failed.

16. The computer-implemented method of claim 14, wherein the first frame includes an element that includes (i) information identifying the SMD, (ii) information describing one or more capabilities of the SMD, or (iii) information describing one or more constraints of the SMD.

17. The computer-implemented method of claim 14, wherein the second frame includes an element that includes (i) information identifying the SMD, (ii) information describing one or more capabilities of the SMD, or (iii) information describing one or more constraints of the SMD.

18. The computer-implemented method of claim 14, further comprising:
establishing a single pairwise master key security association (PMKSA) with a management entity of the SMD using the SMD identifier, wherein the PMKSA includes an SMD level pairwise master key (PMK).

19. The computer-implemented method of claim 14, further comprising:
communicating with a management entity of the SMD to associate with the SMD.

20. The computer-implemented method of claim 19, further comprising:
deriving an SMD level pairwise transient key (PTK) between the STA and the management entity of the SMD using the SMD identifier.
